(19) United States
(12) Patent Application Publication
(10) Pub. No.: US 2008/0315737 A1
(43) Pub. Date: Dec. 25, 2008

(54) In-Wall Mounted Toolbox

(76) Inventor: Jason Hammond, Austin, TX (US)

Correspondence Address: FISH & RICHARDSON P.C., P.O BOX 1022, Minneapolis, MN, 55440-1022, US

(21) Appl. No.: 11/766,014

(22) Filed: Jun. 20, 2007

(51) Int. Cl. B25H 3/02; A47B 81/00; A47B 96/00; B25H 3/00

(52) U.S. Cl. 312/242; 206/372

(57) ABSTRACT

An in-wall mounted tool box has a rectangular base having two opposing side panels, opposing top and bottom panels, and a back panel that form a storage cavity. Flanges are coupled to edges on the side panels of the rectangular base for mounting the rectangular base to vertical members forming a wall thickness. The back panel of the tool box has a number of tool hangers attached wherein tools may be stored. The in-wall tool box is configured to mount between two studs of an interior wall. A portion of the wall covering is removed exposing the stud surface over a length corresponding to the height of the in-wall tool box. The flanges are coupled to the stud walls with fasteners and tool box extends into the volume between two studs. The flanges may have pre-drilled clearance holes to facilitate mounting of the tool box to the wall studs.

### TECHNICAL FIELD

The present invention relates in general to tool boxes, and more particularly to wall mounted tool boxes.

### BACKGROUND

Tool boxes come in all shapes and sizes and are normally configured for the size of tools that they store, portability and access by the consumer. Most tool boxes have some types of partitions, slots, drawers, etc. that are configured to hold tools or parts of various sizes. Tool boxes may be further classified as products for the general consumer and those for the professional, for example, automobile mechanics. Most general consumers either place their tool boxes in their car or in some designated place in their garage. As is well know, most personal garages are cluttered by normal standards and the general consumer is always trying to better organize those things normally stored in the garage to allow for parking an automobile or to allow items to be conveniently accessed. Tools are one of those item types that often get relegated to tool boxes that become difficult to access in such a cluttered environment.

There is, therefore a need for a tool box that is configured to be installed in a way that it is easily accessed and such that it does not add further clutter to the garage or other room in which it is most frequently used.

### SUMMARY

An in-wall mounted tool box has a rectangular base having two opposing side panels, opposing top and bottom panels, and a back panel that form a storage cavity having a height, width and depth. Flanges are coupled to edges on the side panels of the rectangular base for mounting the rectangular base to vertical members forming a thickness of a wall. The back panel of the tool box has a number of tool hangers attached wherein tools may be stored. The in-wall tool box is configured to mount between two studs of an interior wall. A portion of the wall covering is removed exposing the stud surface over a length corresponding to the height of the in-wall tool box. The flanges are coupled to the stud walls with fasteners and the in-wall tool box extends into the volume between two studs. In one embodiment the flanges have pre-drilled clearance holes to facilitate mounting of the tool box to the wall studs.

In another embodiment, the a door is hingedly coupled to an edge of one of the side panels. The door includes a latch with or without a key for securing stored tools when closed over the cavity of the tool box.

In another embodiment, the bottom panel has a slot that allows clearance for a vertical drawer unit. The side walls are fitted with a slider that holds and guides the vertical drawer unit up and down in the vertical direction. In the up position, the vertical drawer covers the back panel of the tool box. In the down position, the vertical drawer extends into the volume of the covered wall below the rectangular base of the tool box. The vertical drawer is fitted with additional tool hangers and may also have mini drawers for storing screws or other small parts.

In one embodiment the vertical drawer also has a door that is closed over its storage cavity and secured with a latch again with or without a key lock. The tool box is configured with elements that constrain the rate of motion of the vertical drawer especially in the vertical down direction. A latch mechanism is used to hold the vertical drawer in the up position and in the down position.

In another embodiment, the flanges have clearance holes with slots for mounting to fasteners. In this manner, the in-wall tool box may be hung in an opening without the fasteners having to be further adjusted to hold the tool box. In this embodiment the top panel of the tool box is fitted with a handle to facilitate transport of the in-wall tool box when it is removed from a wall mounting. The flanges may also be configured to fold back in contact with the side panels of the tool box such that the edges of the flanges do not present a “snag” hazard when the tool box is being transported.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is an embodiment of an in-wall tool box showing the sides, top, back, bottom with an open slot for a vertical drawer, and flanges with mounting holes;

FIG. 1B is an embodiment of an in-wall tool box without the open slot in the bottom for a vertical drawer

FIG. 2 is an embodiment of an in-wall tool box with a door and a hinge for securing stored tools; and

FIG. 3 is the embodiment of FIG. 1A showing a corresponding vertical drawer;

FIG. 4 illustrates a wall with studs and an in-wall tool box installed between two adjacent studs; and

FIG. 5 is another embodiment of an in-wall tool box.

Like reference symbols in the various drawings indicate like elements.

### DETAILED DESCRIPTION

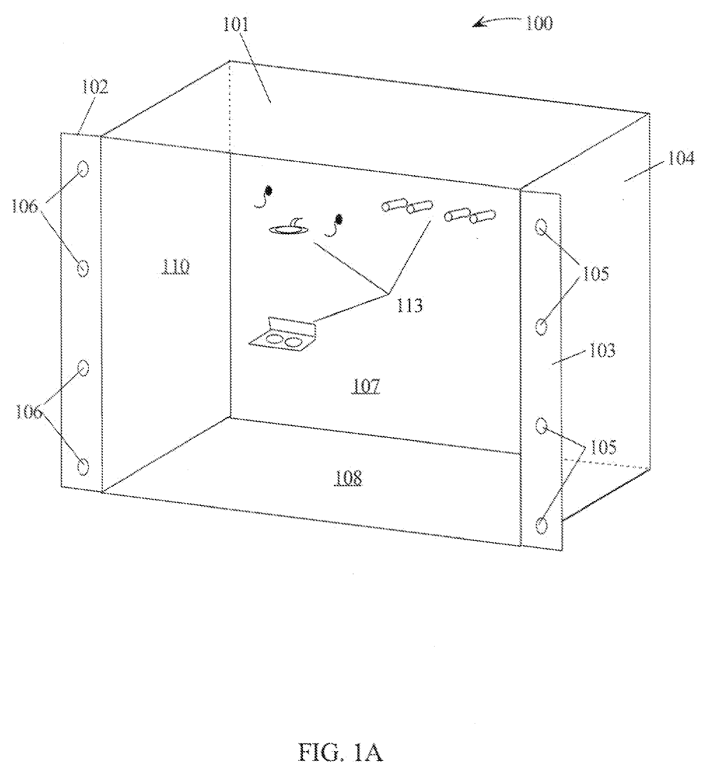

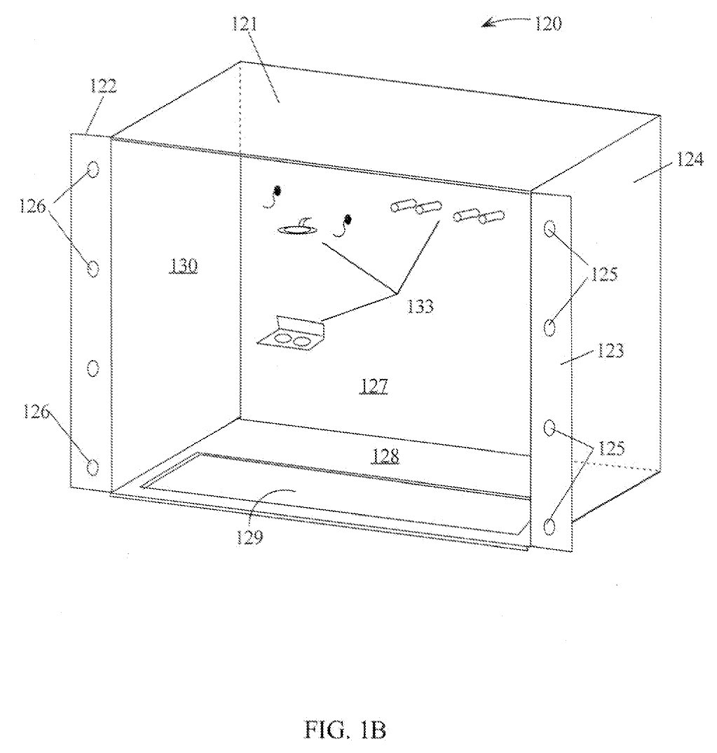

FIG. 1A is an embodiment of an in-wall tool box 100. This embodiment has side panels 104 and 110, top panel 101, back panel 107 and bottom guard 108 without a slot for a vertical drawer. Flanges 102 and 103 have mounting holes 106 and 105, respectively. Tool box 100 is configured to fit between studs of a wall found in a typical garage or work room. Flanges 102 and 103 are configured to overlap the thickness of the studs and nails or screws (not shown) may be used to secure the in-wall tool box 100 to the studs will allowing the body of tool box 100 to extend into the wall thickness. This provides a tool box that is substantially flush with the wall surface. Various tool hangers 113 are attached to back panel 107 for storing tools.

FIG. 1B is an embodiment of an in-wall tool box 120. This embodiment has side panels 124 and 130, top panel 121, back panel 127 and bottom panel 128 with a slot 129 offering a clearance for a vertical drawer (not shown). Flanges 122 and 123 have mounting holes 126 and 125, respectively. Tool box 120 is also configured to fit between studs of a wall found in a typical garage or work room. Flanges 122 and 123 are configured to overlap the thickness of the studs and nails or screws (not shown) may be used to secure the in-wall tool box 120 to the studs will allowing the body of tool box 120 to extend into the wall thickness. This provides a tool box that is substantially flush with the wall surface. Various tool hangers 133 are attached to back panel 307 for storing tools.

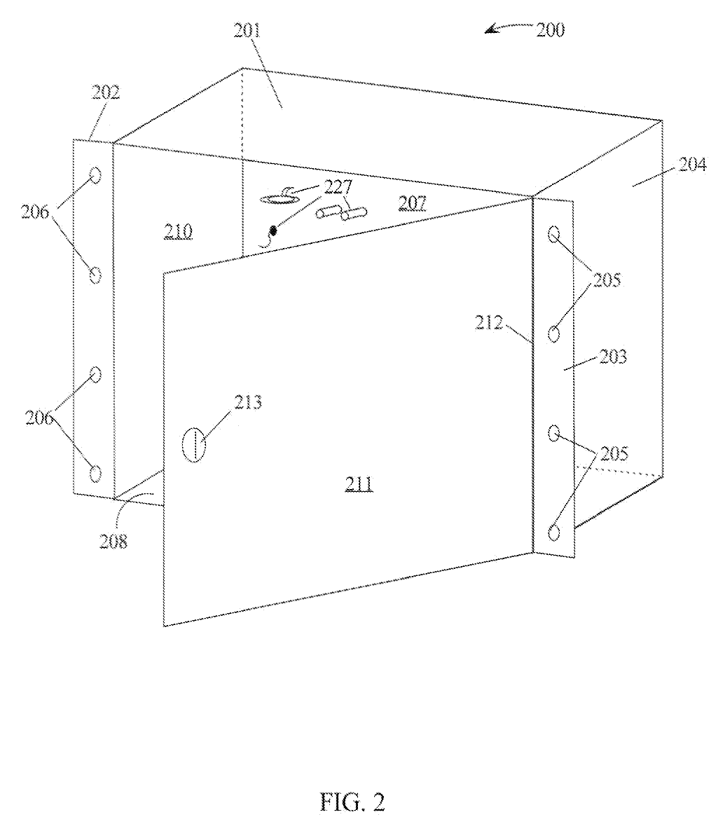

FIG. 2 is an embodiment of an in-wall tool box 200 fitted with a door 211 with hinge 212 and latch 213. This embodiment has side panels 204 and 210, top panel 101, back panel 207 and bottom panel 208 forming a storage cavity. Tool hangers 227 are attached to back panel 207 for storing tools. Door 211 functions to secure tools stored in the storage cavity. Flanges 202 and 203 have mounting holes 206 and 205, respectively. Tool box 200 is configured to fit between studs of a wall found in a typical garage or work room. Flanges 202 and 203 are configured to overlap the thickness of the studs and nails or screws (not shown) may be used to secure the in-wall tool box 200 to the studs will allowing the body of tool box 200 to extend into the wall thickness. This provides a tool box that is substantially flush with the wall surface.

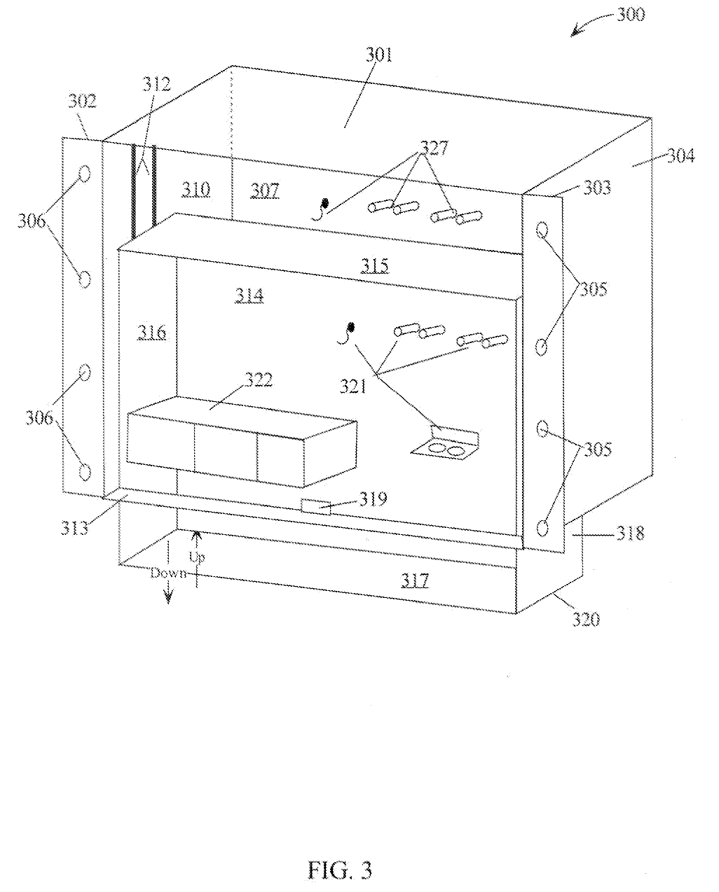

FIG. 3 is an embodiment of an in-wall tool box 300. This embodiment has side panels 304 and 310, top panel 301, back panel 307 and bottom panel 308 with a slot (not shown) offering a clearance for vertical drawer 320. Vertical drawer unit 320 has side panels 316 and 318, a top panel 315, a bottom panel 317 and a back panel 314. Sliders 312 are placed on each side 310 and 304 to constrain and guide drawer 320 as it is moved UP and DOWN in the vertical direction. Drawer 320 is additionally configured with springs or some form of elastic constraint (not shown) that control the rate of motion of drawer 320 in the DOWN direction. Tool box 300 is configured with a latching mechanism 319 that holds the vertical drawer fixed when extended in the DOWN position into a covered volume of the wall or when in the UP position. In this way, additional mounting surface (back 314) is made available for holding tools with tool hangers 321. Likewise, vertical drawer unit 320 may be fitted with mini-drawers 322 that move orthogonal with the back 314 for storing small items like screws, nails, etc. Ledge 313 is part of the slot (not shown e.g., 129 FIG. 1B) for drawer 320. Back panel 307 is fitted with tool hangers 327 for mounting additional tools.

Flanges 302 and 303 have mounting holes 306 and 305, respectively. Tool box 300 is configured to fit between studs of a wall found in a typical garage or work room. Flanges 302 and 303 are configured to overlap the thickness of the studs and nails or screws (not shown) may be used to secure the in-wall tool box 300 to the studs while allowing the body of tool box 300 to extend into the wall thickness. This provides a tool box that is substantially flush with the wall surface.

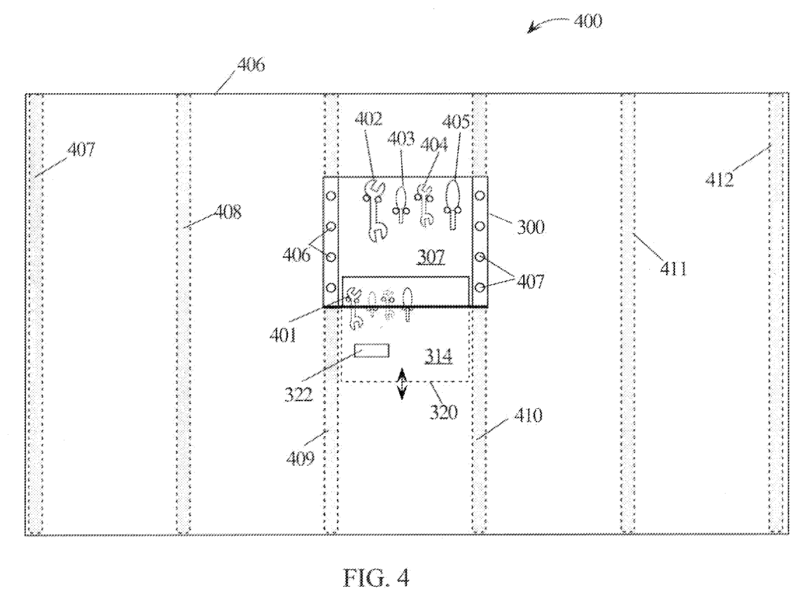

FIG. 4 illustrates a wall section 400 showing studs 407-412 beneath wall surface 406. In-wall tool box 300 is mounted in an opening in wall section 400 between studs 409 and 410. Tools 402-405 are mounted on back panel 307 using any one of a number of possible types of tool hangers. These tool hangers include but are not limited to hooks, pegs, panels with holes mounted orthogonal to the back panel, attached magnets, spring loaded clamps, forked hooks, etc. Additionally, tools 401 are mounted on the back panel 314 of vertical drawer unit 320 using the aforementioned hanger types. Fasteners 405-406 are applied through the holes 305-306 in flanges 303-302, respectively, to secure tool box 300 in the wall 400.

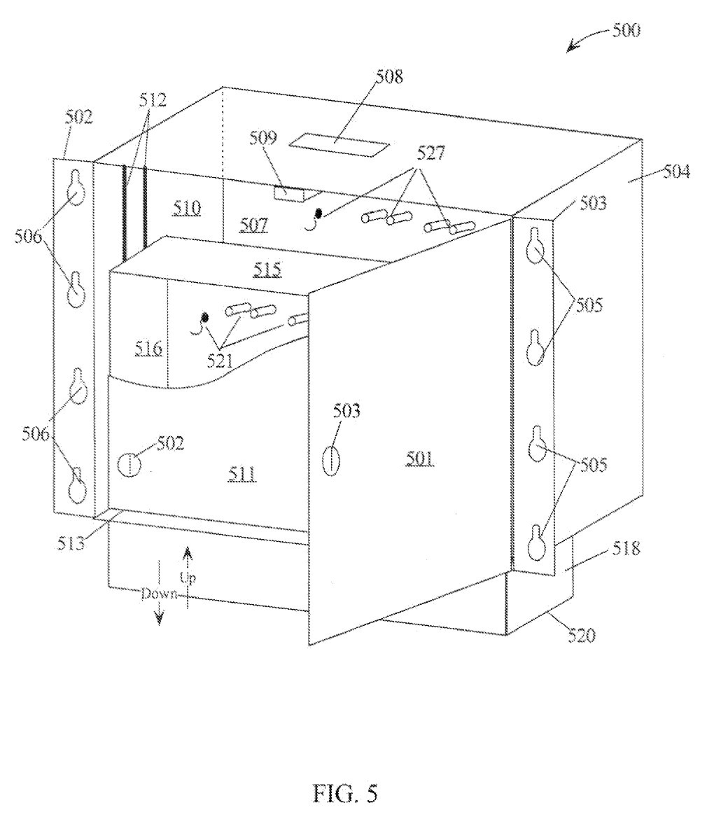

FIG. 5 illustrates another embodiment of an in-wall tool box 500. Tool box 500 has a vertical drawer unit 520 that moves UP into the volume of tool box 500 and DOWN into a volume of a cover wall to which tool box 500 is mounted. Vertical drawer unit 520 has side panels 516 and 518, a top panel 515, a bottom panel 517 and a back panel 514. Back panel 507 has tool hangers 527 for storing tools. Sliders 512 are placed on each side 510 and 504 to constrain and guide drawer 520 as it is moved UP and DOWN in the vertical direction. Vertical drawer 520 is fitted with a door 524 that has a latch 522 for securing the door in a closed position covering the interior of vertical drawer 520. Vertical drawer unit 520 moves on sliders 512 attached to side panels 504 and 510. Latch 509 is used to secure the vertical drawer unit 520 in the UP position. Ledge 513 is part of the clearance slot for drawer 520.

A handle 508 enables the tool box 500 to be transported when removed from a wall mount. Mounting holes 506 and 505 in flanges 502 and 503 are slotted so that tool box 500 may be lifted in the UP direction and removed from fasteners (e.g., 405-406) without having to extract the fasteners from the studs of the wall. Flanges 503 and 504 may be configured to fold out of the way when tool box 500 is removed from a wall to prevent edges of the flanges from catching on clothing, etc. Tool box 500 has door 511 and latch 523 for securing door 511 in the closed position covering vertical drawer unit 520.

A number of embodiments of the invention have been described. Nevertheless, it will be understood that various modifications may be made without departing from the spirit and scope of the invention. Accordingly, other embodiments are within the scope of the following claims.

What is claimed is:

1. An in-wall mounted tool box comprising:
a box shaped rectangular base forming a cavity having a height, a width, and a depth, the base having two opposing side panels, opposing top and bottom panels, and a back panel;
flanges coupled to edges on the side panels of the rectangular base for mounting the rectangular base to vertical members forming a thickness of a wall; and
a plurality tool hangers coupled to an exposed surface of the back panel for receiving and holding a plurality of tools.

2. The tool box of claim 1 further comprising a first door for covering an opening to the cavity of the rectangular base.

3. The tool box of claim 2, further comprising a latch for securing the first door in a closed position.

4. The tool box of claim 1, wherein the vertical members are studs uniformly spaced to form a length of the wall.

5. The tool box of claim 1, wherein the flanges are pre-drilled with holes to facilitate mounting to the vertical member with a fastener.

6. The tool box of claim 5, wherein the bottom panel has a slot opening to a covered wall volume below the rectangular base when mounted between two studs of the wall.

7. The tool box of claim 6, wherein a surface of at least one of the opposing side panels of the rectangular base has slides for coupling to and guiding a vertical drawer unit that translates vertically between a volume of the rectangular base and the covered wall volume.

8. The tool box of claim 7, wherein the vertical drawer unit is configured to latch when slid into the volume of the rectangular base.

9. The tool box of claim 8, wherein a back surface of the vertical drawer unit is fitted with additional storage elements for holding one or more tools.

10. The tool box of claim 9, wherein the vertical drawer unit has a second door for covering its storage cavity opening and securing stored tools.

11. The tool box of claim 10, wherein the vertical drawer unit has a constrained rate of motion when moved into the wall volume.

12. The tool box of claim 11, wherein the vertical drawer unit and the rectangular base are cooperatively configured to latch the vertical drawer when it is slid into the covered wall volume.

13. The tool box of claim 12, wherein the vertical drawer unit additionally has a plurality of drawer units that slide orthogonal to the back surface of the vertical drawer unit to provide access to a corresponding storage cavity of the drawer units.

14. The tool box of claim 3, wherein the latch on the first door further comprises a key lock for securing the door in a closed position.

15. The tool box of claim 1, wherein the depth of the rectangular base is sized so that the rectangular base is substantially flush with a surface of the wall when mounted to the vertical members.

16. The tool box of claim 5, wherein the predrilled holes have a clearance opening and a slotted opening; the slotted portion configured to fit over a cylindrical portion of a fastener for holding the tool box to the vertical member of the wall, and the clearance opening configured to allow the tool box to be lifted off of the fastener.

17. The tool box of claim 16, further comprising a handle recessed into the top panel of the rectangular base, the handle facilitating transporting the tool box when removed from a wall.

18. The tool box of claim 17, wherein the flanges are hinged to fold against the side panels of the rectangular base.

19. The tool box of claim 10, wherein the second door is fitted with a soft padding that compresses against stored tools or drawer units holding these items secure when the second door is in a closed position.

20. The tool box of claim 19, further comprising a padded panel for fitting over stored tools on the back panel of the rectangular base thereby securing the stored tools when the tool box is transported.

21. The tool box of claim 2, wherein an inside surface of the first door is fitted with one or more tool hangers for receiving and holding a tool.
